(19) United States
(12) Patent Application Publication
(10) Pub. No.: US 2006/0026055 A1
(43) Pub. Date: Feb. 2, 2006

(54) Longitudinal performance management of product marketing

(76) Inventors: David Gascoigne, Downington, PA (US); Lisa Kerber, Lafayette Hill, PA (US); David Jones, Montgomery, PA (US)

Correspondence Address: BAKER & BOTTS, 30 ROCKEFELLER PLAZA, NEW YORK, NY, 10112, US

(21) Appl. No.: 11/125,560

(22) Filed: May 10, 2005

Related U.S. Application Data
(60) Provisional application No. 60/569,975, filed on May 10, 2004.

(51) Int. Cl. G06F 17/30

(52) U.S. Cl. 705/10

(57) ABSTRACT

Longitudinal performance management solutions are provided for enhancing the effectiveness of product marketing efforts in dynamic market conditions. The solutions are configured to assess market conditions by analyzing multiple interacting market factors, which collectively influence product market performance. The analysis involves non-linear multivariate algorithms which can identify critical performance indicators, trends, and changing market conditions. The solutions may be deployed for analysis to identify key current market drivers or factors. Timely product marketing activities are fashioned to respond to dynamic market conditions on the basis of the identified market drivers or factors

### CROSS REFERENCE TO RELATED APPLICATION

This application claims the benefit of U.S. provisional patent application Ser. No. 60/569,975 filed May 10, 2004, which application is hereby incorporated by reference in its entirety herein.

### BACKGROUND OF THE INVENTION

The present invention relates to techniques for optimization of sales and marketing efforts. The invention in particular relates to systems and methods for assessing market performance and the status of multiple market variables, which influence the eventual commercial success of the product, throughout a product marketing cycle.

In traditional business environments, the success or effectiveness of a marketing campaign for products entering the market is not be known until after the marketing campaign has run its full course. In some instances full development of a product in the market space may take months or years from the initial introduction of the product in a market. Usual marketing campaigns or strategies are based on market research data collected prior to product introduction (e.g., during product concept definition). Unfortunately, such marketing campaigns or strategies based on historic data are hit-or-miss propositions that are not suitable for markets that exhibit dynamic behavior. Further, the strategies may be based on market research data on an isolated market variable ignoring the interactive effects of other market variables on market behavior.

Consideration is now being given to improving systems and methods for product marketing. In particular, attention is paid to the product marketing in an environment in which several interacting market variables can influence results.

### SUMMARY OF THE INVENTION

In accordance with the principles of the invention, systems and methods are provided for improving the effectiveness of a product marketing effort. The systems and methods are configured to analyze multiple interacting market variables and their impact on the product's market performance. The systems and methods can be deployed for periodic analysis of the market conditions to identify current key market driving variables. Based on the identification of the current market driving variables, product marketing activities may be dynamically optimized in response to unanticipated or evolutionary changes in market conditions.

The systems and methods involve market data integration followed by multi-variate analysis of the integrated data. In the data integration steps, primary market research data is integrated with secondary market and/or reference data. In applications involving a pharmaceutical or medical products, primary market research data such as physician attitudes and perceptions may be collected directly from a panel of prescribing physicians. The secondary market data such as prescribing behaviors may obtained by tracking, for example, patient prescriptions serviced or filled by drugstores, pharmacies or other healthcare channels.

The combined data may be assembled in a comprehensive longitudinal database linking physician attitudes and perceptions of market products with prescribing behaviors. Statistical response models may be used to quantitatively link physician attitudes/perceptions (of the subject product and alternate or competing products) and the physicians' prescribing behavior. The models may be helpful in determining or analyzing the actual impact of promotion, attitudes and perceptions on prescribing behavior. The response models may provide actionable insights and to support marketing decisions. The response models may be used to refine marketing efforts of the subject product.

The systems and methods may be implemented via any suitable combination of computer software and hardware in conjunction with marketing, research or service organizations and entities. The combination is designed to integrate primary market research data and secondary market data, and further to periodically analyze the integrated data to assess and provide early warnings of changes in market conditions. The periodic analysis of the integrated market data involves non-linear multi-variate analysis, which leads to contemporaneous identification of the key market driving variables. On the basis of this identification, product marketing actions that are responsive to dynamic market conditions, can be optimized.

Further features of the invention, its nature and various advantages will be more apparent from the accompanying drawing and the following detailed description.

### BRIEF DESCRIPTION OF THE DRAWINGS

FIG. 1a is block diagram representation of an exemplary longitudinal market performance management solution, in accordance with the principles of the present invention.

FIG. 1b is an illustration of the longitudinal data integration concepts that underlie longitudinal market performance management solution for analysis of the multiple factors affecting pharmaceutical product market performance, in accordance with the principles of the present invention.

FIG. 2 is a listing of exemplary analysis or applications, which may be included in a longitudinal market performance management solution, in accordance with the principles of the present invention. FIG. 2 also lists exemplary delivery vehicles and tools for interfacing the solution with users and customers, in accordance with the principles of the present invention.

FIGS. 3a and 3b are illustrations of the components and subcomponents of and exemplary longitudinal market performance management solution, in accordance with the principles of the present invention.

FIG. 4 is a graph illustrating the critical growth challenges that may be faced during the entire growth cycle of a product.

FIG. 5 is a schematic representation of the complex decision making, which may be involved in optimizing marketing activities for a particular product in a complex and dynamic multi-variable market environment.

FIG. 6 is a time line representation of the early warnings provided by periodic assessments of market conditions obtained using longitudinal market performance management solutions in accordance with the principles of the present invention.

FIG. 7 is a time line representation of the prior art methodologies for analyzing complex markets.

FIG. 8 is a graphical representation of the developing market share of a pharmaceutical product which is marketed using a longitudinal market performance management solution in accordance with the principles of the present invention.

FIG. 9 is a schematic representation of an application of a longitudinal market performance management solution to develop product market share in a complex market, in accordance with the principles of the present invention.

FIG. 10 is a schematic representation of the components of a longitudinal market performance management solution in accordance with the principles of the present invention.

FIGS. 11 and 12 are representations of exemplary weekly and monthly status results for several market variables by a longitudinal market performance management solution in accordance with the principles of the present invention. The multiple variable results are displayed in dashboard format for easy visual comparison.

FIGS. 13 and 14 are representations of the application of longitudinal market performance management solutions to optimization of promotion effectiveness for an individual product and a portfolio of products, respectively, in accordance with the principles of the present invention.

FIG. 15 is a graph comparing the market share development of a product marketed using the longitudinal market performance management solutions of the present invention and the market share of a competitor product.

### DESCRIPTION OF THE INVENTION

The present invention provides systems and methods for improving product sales and marketing efforts. In particular, the systems and methods are designed to improve the efficiency of product sales and marketing efforts by making the efforts responsive to dynamic market behavior. Market research tools, algorithms, are provided for integrated multi-variable analysis of market dynamics and market characteristics that may be of significance to a particular product's market performance.

The inventive systems and methods may involve periodic assessments of the market performance of the subject product and competitor products or brands during the course of a marketing promotion. The assessments are based on evaluation of longitudinal data encompassing several interacting market variables. The periodic assessments may optionally be coupled with promotion return on investment (ROI) and driver analysis on the completion of the marketing promotion. The inventive systems and methods are hereinafter collectively referred to as longitudinal performance management (“LPM”) solutions.

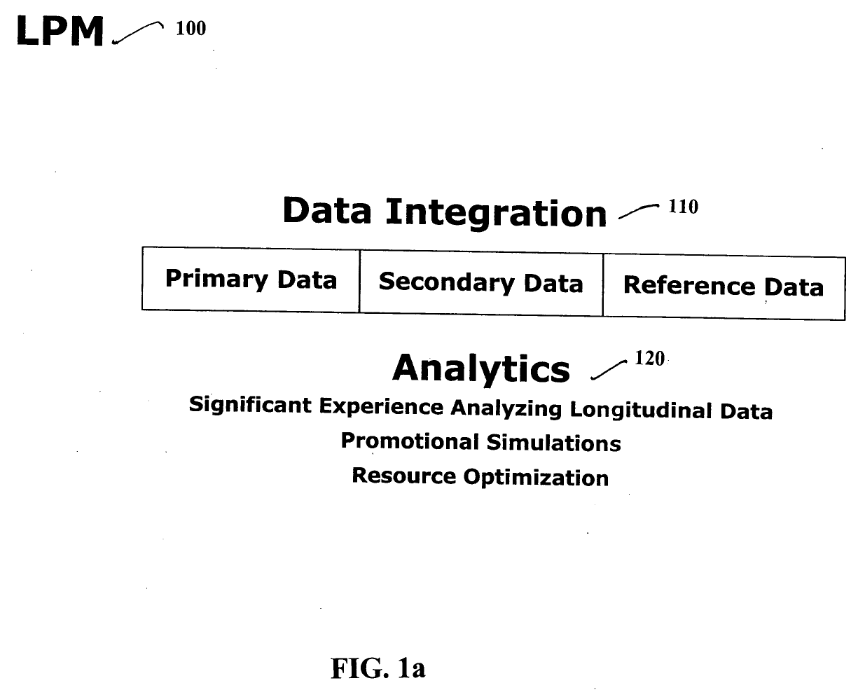

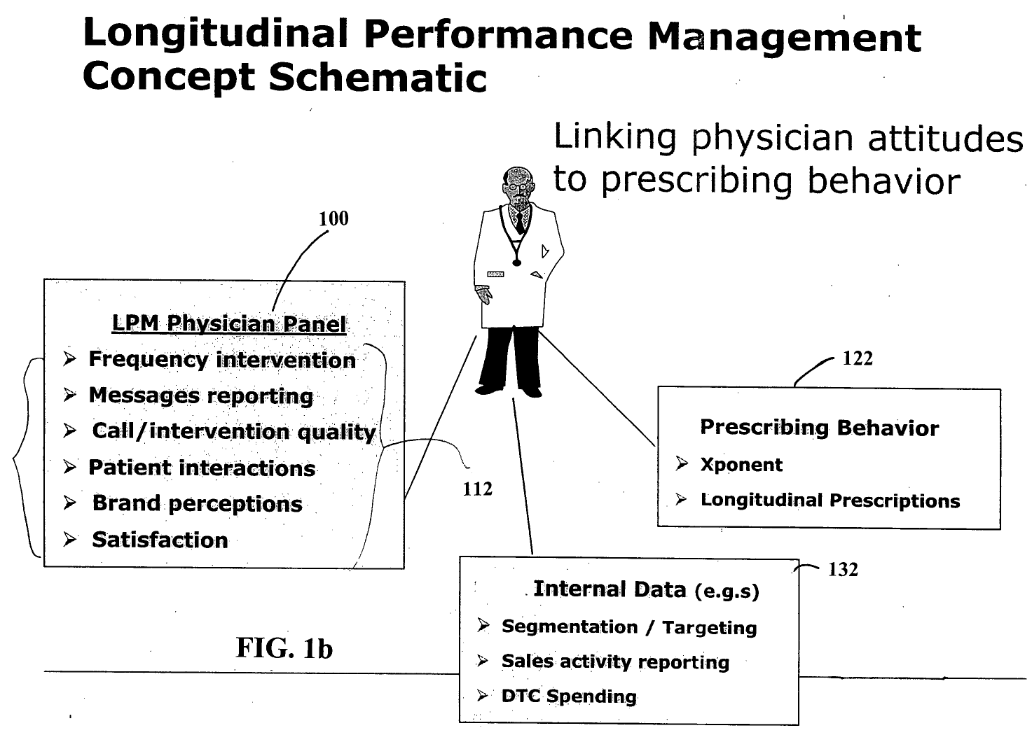

FIG. 1a is a block diagram, which schematically represents an LPM solution 100. LPM solution 100 involves longitudinal integration of market data (step 110), and analysis of the longitudinally integrated data (step 120). The longitudinally integrated market data may include both primary market research data, secondary market data, and also reference data. The data analysis, which may involve non-linear multi-variate programming and optimization algorithms, may be coupled with marketing promotion simulators and resource optimization algorithms. The LPM solution is designed to assess key market drivers and to provide a user/decision-maker with the means (i.e. marketing levers) to manage market performance of a subject product. The LPM solution may be applied to the marketing promotion of any product. An exemplary subject product may be a new launch, a re-launch, a re-positioning, or an introduction of a product extension. The LPM solution may enable a decision-maker to utilize key performance indicators or metrics to drive product success throughout the course of the marketing promotion.

The invention is described further herein in the exemplary context of pharmaceutical and medical products, whose sales are often influenced by the prescribing behavior of physicians. Pharmaceutical companies often develop markets for their specific products or brands in a target geography or territory by using a sales force to make contact with or call on prescribing practitioners (e.g., physicians, doctors and nurses) in the territory. The salespersons in the sales force may, for example, call on a large number of target practitioners to introduce them to new products. The salespersons may visit or otherwise interact with the targeted practitioners to encourage continued or increased use of the marketed products and to possibly discourage use of competitor products.

All relevant data used in the LPM solutions may be collected longitudinally from physicians (e.g., on patients, promotions, brand opinions and prescribing decisions), and other healthcare providers (e.g., hospitals, dispensaries, pharmacies, and managed health care providers) and assembled in a comprehensive longitudinal database. The database, which includes attitudinal, perception, and competitive and behavioral data for targeted customers, may be linked with powerful cause-and-effect analysis tools or algorithms to support decision-making. The LPM solutions may be configured to provide rapid assessment of what is happening in the market space and why. The rapid assessment may be used to quickly adjust promotional strategies and tactics in real time or almost real time to drive market results. The LPM solutions provide market research with real-time actionable insights to maximize product performance.

FIG. 1b exemplifies the concept of longitudinally linked data, which underlies the implementation of a LPM solution in the context of pharmaceutical product marketing. In particular, the LPM solution links “physician attitudes” data 112 to “prescribing behavior” data 122. A sample (or panel) of the targeted physicians may be selected or recruited for generating the physician attitudes data. This data may be assembled as a set of the attributes (112). Available market research techniques, including surveys, interviews, or any other suitable market research techniques may be used to collect the physician attitudes data as primary market research data. The prescribing behavior data may be represented by “secondary” prescriber-by-prescriber data. This data may be based on prescription activity observed within the retail, mail-order service, long-term care, and/or specialty retail channels. Commercial tools (e.g., Xponent and LRx, which are sold by the assignee) may be used to collect prescriber-by-prescriber data. The prescriber-by-prescriber data, which may include prescriptions generated across all prescription channels and payment types, can include longitudinally linked prescription data.

Other relevant data (132) also may be longitudinally linked to physician attitudes data 112 and prescribing behavior data 122. Relevant data 132, which may be internal to the product marketing entity, includes, for example, data related to the structure or organization of the marketing effort (e.g., market segmentation and targeting, sales activity reporting, and direct-to-consumer (DTC) spending).

By implementation of a LPM solution, powerful market insights may be gained from analysis of primary physician-based research data combined with secondary prescribing behavior data. Physician-based primary research data may be collected from a customized sample panel of physicians (e.g., panel 100). The physicians may be recruited to periodically report (e.g., weekly) on a set 112 of attributes (e.g., patient treatment variables, promotional exposures, and brand and category related attitudes and opinions). Further, prescribing behavior data (e.g., set 122) may be collected and qualified using commercially available pharmaceutical market research tools such as Xponent and LRx.

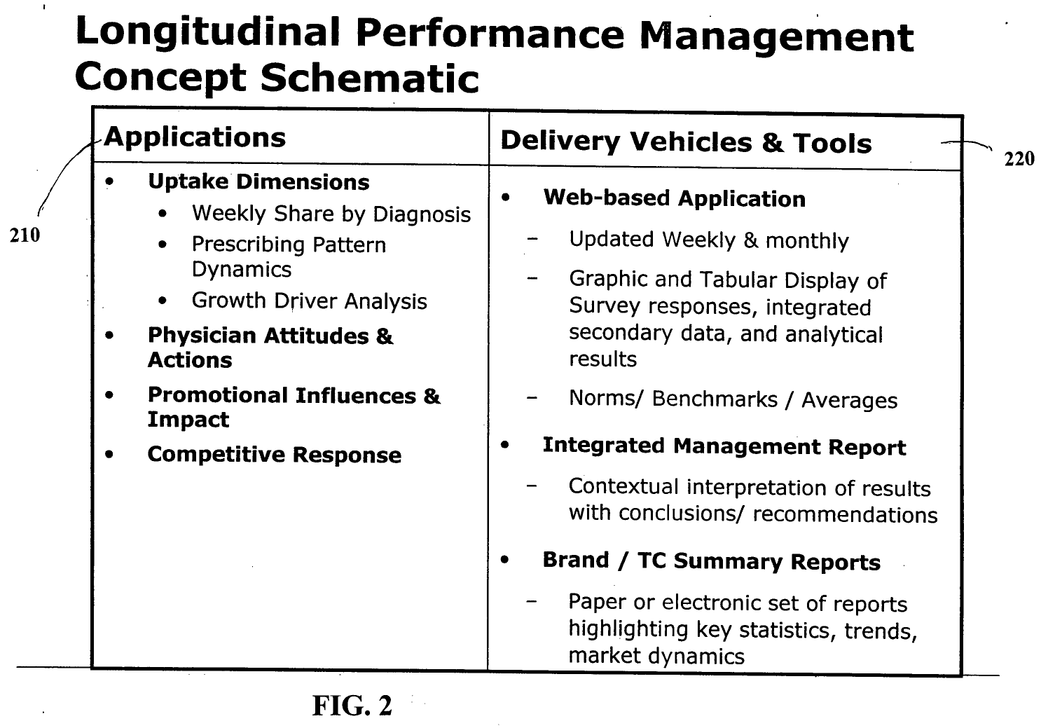

In the LPM solution, physician-based primary research data is integrated with the longitudinal prescription data (e.g., LRx data) to relate, report on and draw conclusions from the relationships between physician attitudes and prescribing-behavior, and the effect of the marketing promotion the relationships. The LPM solution may include suitable applications, algorithms and models for data analysis and the reporting of results. FIG. 2 shows exemplary types of analysis or applications 210, which may be included the LPM solution. FIG. 2 also lists several exemplary delivery vehicles and tools 220 that may be utilized for providing results or otherwise interfacing the LPM solution with users or customers.

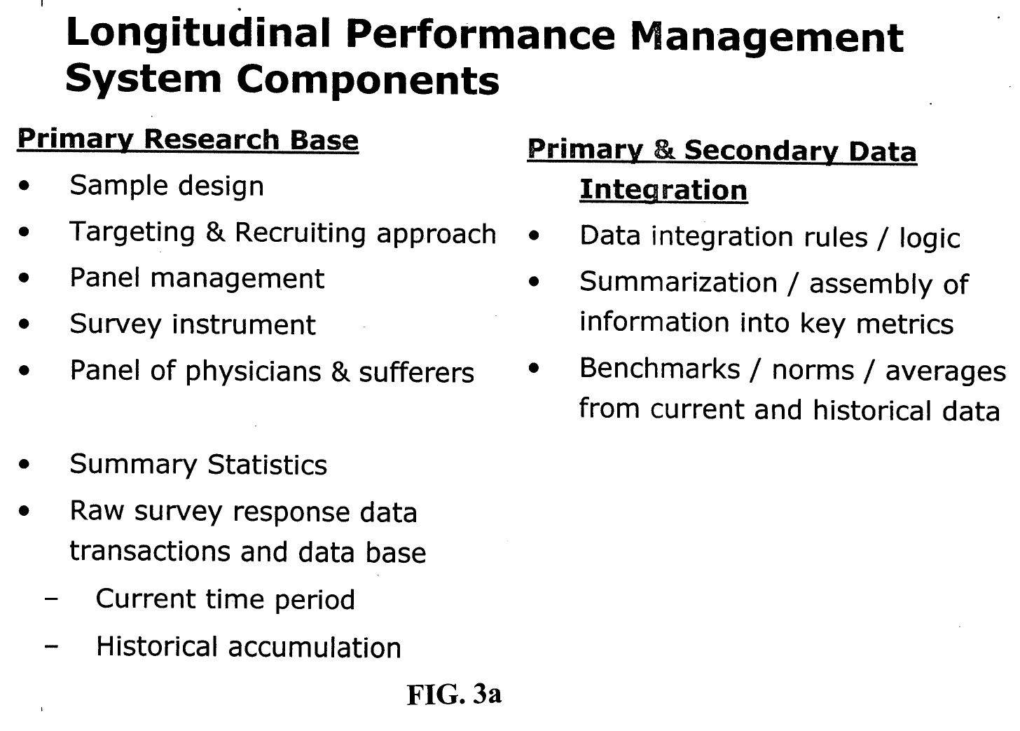

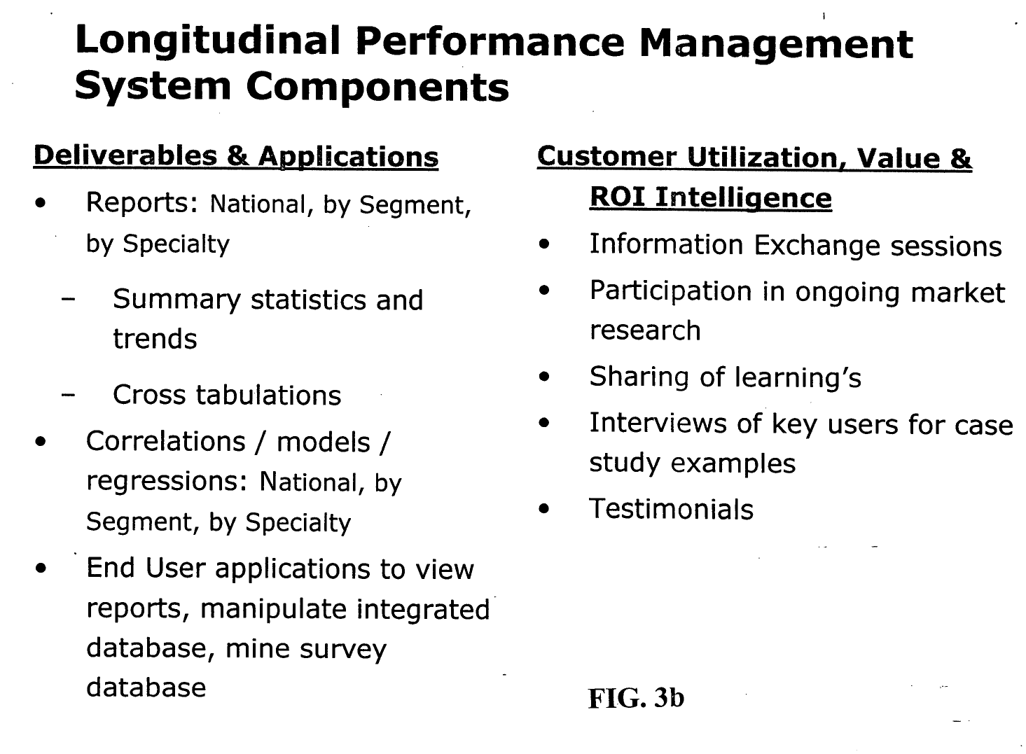

For purposes of illustration, an LPM solution may be viewed as an assembly of modular components, each of which includes a combination of data, applications and models. The components may be implemented by deploying any suitable combination of computer software, hardware and/or personnel (e.g., survey or sales personnel). The components of an LPM solution include the following exemplary modules: a Primary Research Base module; Primary and Secondary Data Integration module; a Deliverables and Applications module, and a Customer Utilization, Value and ROI module. FIG. 3a shows exemplary subcomponents that may be included in the Primary Research Base and the Primary and Secondary Data Integration modules. The Primary Research Base module may include tools, models or algorithms directed toward definition and management of the sample panel of physicians utilized for gathering market data. The subcomponents of the Primary Research Base module shown in FIG. 3a include tools for sample design, targeting and recruitment, panel management, survey instruments, and the panel of physicians and patients. Additionally, the module may include data (e.g., summary statistics, and raw survey response data). The data may include both current and historical data. The Primary Research Base module may include tools, models or algorithms directed toward data integration and management. The exemplary subcomponents of the Primary and Secondary Data Integration module shown in FIG. 3a include applications for data integration rules/logic, summarization, and benchmarks.

Similarly, exemplary subcomponents of the Deliverables and Applications module, and the Customer Utilization, Value and ROI module are listed in FIG. 3b. For brevity of description, a listing of these subcomponents is not repeated in the text herein.

The LPM solution components can be operated in a holistic approach for assessing the market place performance of a product during the critical initial phases of the product launch (e.g., in the first few weeks or months of product launch). The first weeks or months of a new product launch are often critical because market performance in these first months often determines if the product will be a blockbuster or limp along far below expectations. LPM can be advantageously used to tailor or modify the marketing efforts to encourage potential blockbuster products to reach their expected level of performance. LPM provides the ability to stay on top of every aspect of market performance during the marketing effort or promotion.

In the exemplary application to a pharmaceutical product, the LPM solution may link or integrate market data such as prescribing behavior, detailing and sampling activity, physician perceptions of product performance, and branding activities, and assess the impact that each data type or variable has on the other data types or variables. In the LPM solution, the market dynamics affecting the pharmaceutical product may be understood by tracking the following data types: Frequency of interventions, Message recall, Detail quality, Patient interactions with physicians, Physician perceptions of product performance, Reported and anticipated prescribing behavior, and Actual prescribing behavior. The LPM solution may integrate these data types to provide an integrated view of the market. The LPM solution may be configured to provide the integrated view and analysis of the market at any suitable frequency (e.g., weekly). The suitable frequency may be selected to capture details of the market dynamics especially in the formative or initial phases of market development after product entry or launch.

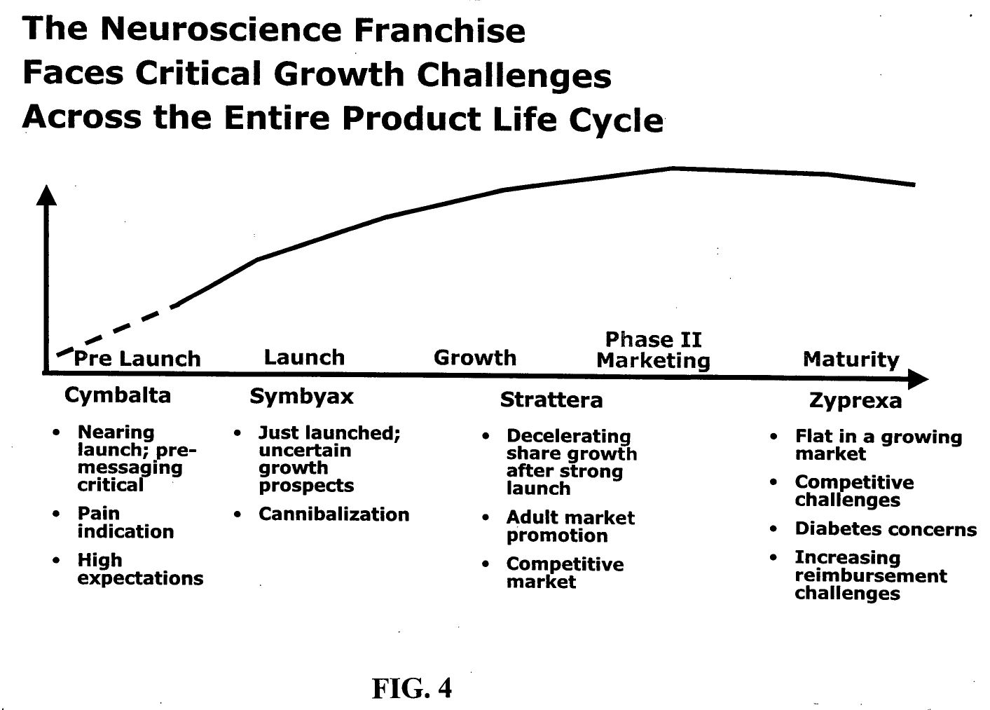

FIG. 4, which shows a graph of product maturation in a market, also lists the exemplary critical growth challenges that may be faced at successive stages in the market development of various products. By focusing on market dynamics during the early stages of market development (i.e. on the pre-launch phase), the LPM solution can capture the significant developments or changes in the market place that are likely to affect eventual product success. The LPM solution can capture important signs of missteps or previously unidentified opportunities in a timely manner to make the marketing effort or promotions more effective. Further, the LPM solution may optimally address market research needs during a new product's launch period. In addition, to providing early warnings on market dynamics and drivers of brand performance, the LPM solution may be configured to provide complete visibility of competitive activity before and during the critical time periods following a product launch.

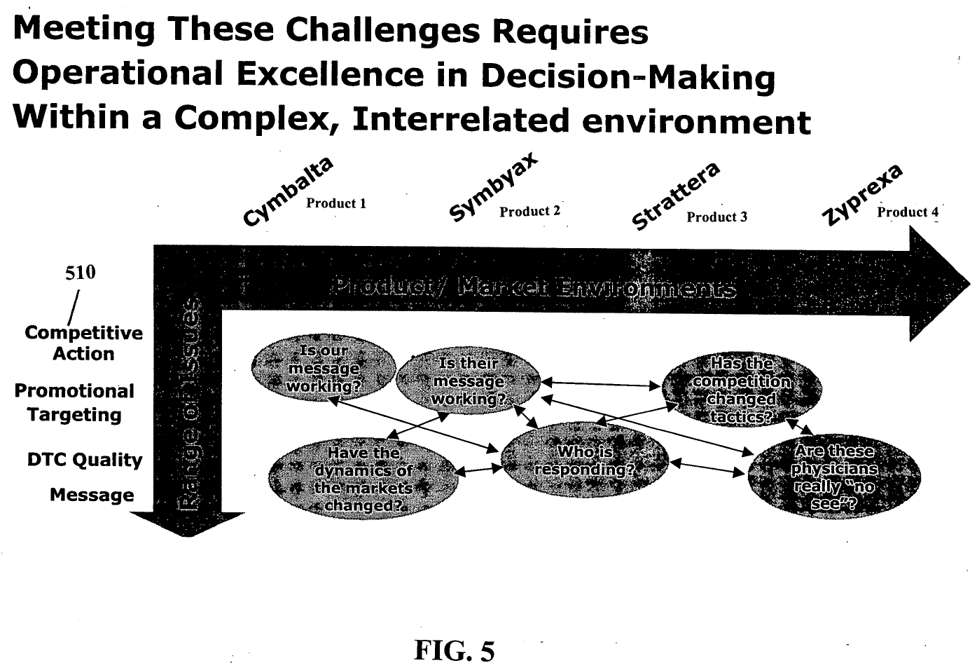

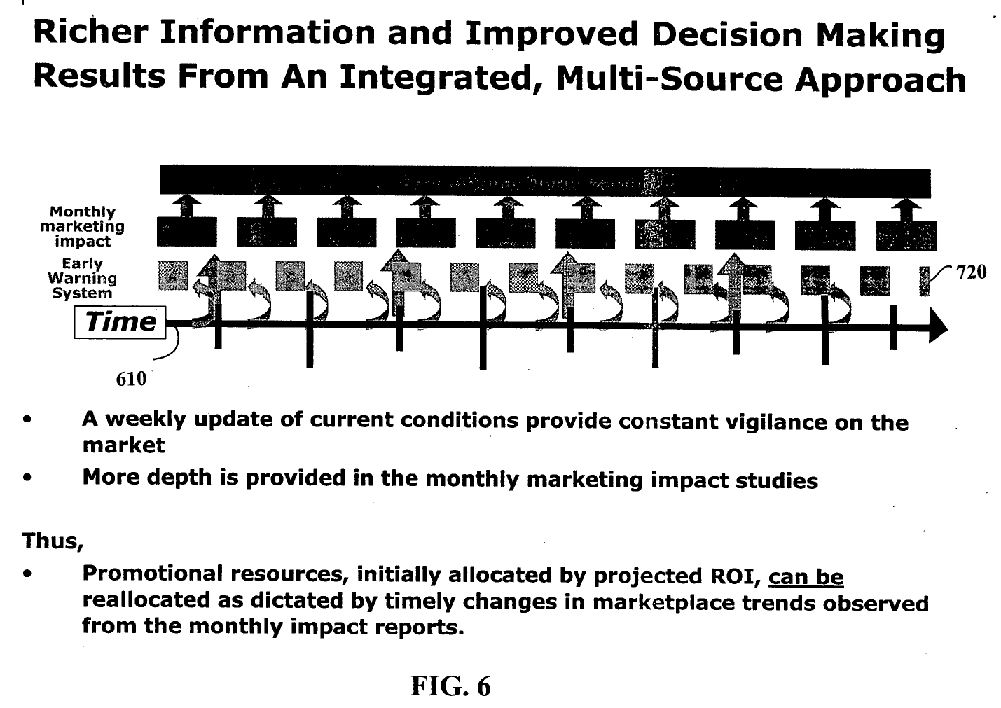

The LPM solutions are configured to provide a sound basis for decision-making in complex interrelated product and market environments. FIG. 5 shows schematically, for example, a range of issues 510 that may arise in the marketing of competitive products of varying maturity in a complex market environment. The LPM solutions address the complexity of market dynamics by longitudinal analysis of multi-sourced market data on a regular basis (e.g., weekly or monthly). Based on this analysis, the LPM solutions can provide quantitative support for resource allocations, corrective measures and new initiatives to address a broad range of problems in an accurate and timely manner. FIG. 6 is a schematic, which exemplifies the benefits of continuous market monitoring and the integrated analysis provided by the LPM solution for optimizing product promotion. With reference to FIG. 6, which shows a time line 710 progressing from left to right through the course of a product promotion, an LPM solution may be configured to make current assessments (720) of market conditions on a weekly or monthly basis. The current assessments 720 may include tracking of physicians over time and integration of message recall, brand equity and other vital product metrics. Current assessments 720 provide an early warning system of changes in the market conditions. The LPM solution is configured evaluate the marketing impact (730) of market changes or responses (720) on a weekly or monthly basis. These periodic marketing impact studies may allow users/decision-makers to reallocate resources in a live response to evolving market trends. Thus, the LPM solution provides superior decision-making support compared to prior art non-integrated market research methodologies, which involve point of time studies.

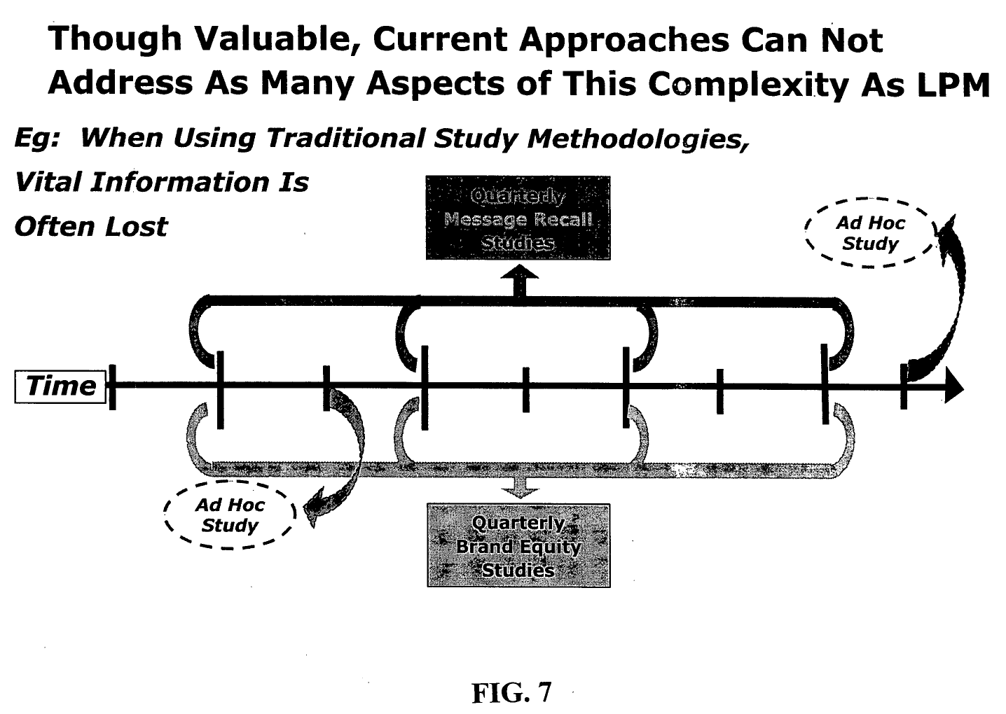

The prior art non-integrated market research methodologies do not involve tracking of physicians over time and lack integration of message recall, brand equity and other vital product metrics (See e.g., FIG. 7). The prior art methodologies are characterized by ad hoc studies and independent quarterly brand equity or message recall studies, in which valuable information on the evolution of physician perceptions and message recall of marketing information is lost and unavailable to user/decision-makers.

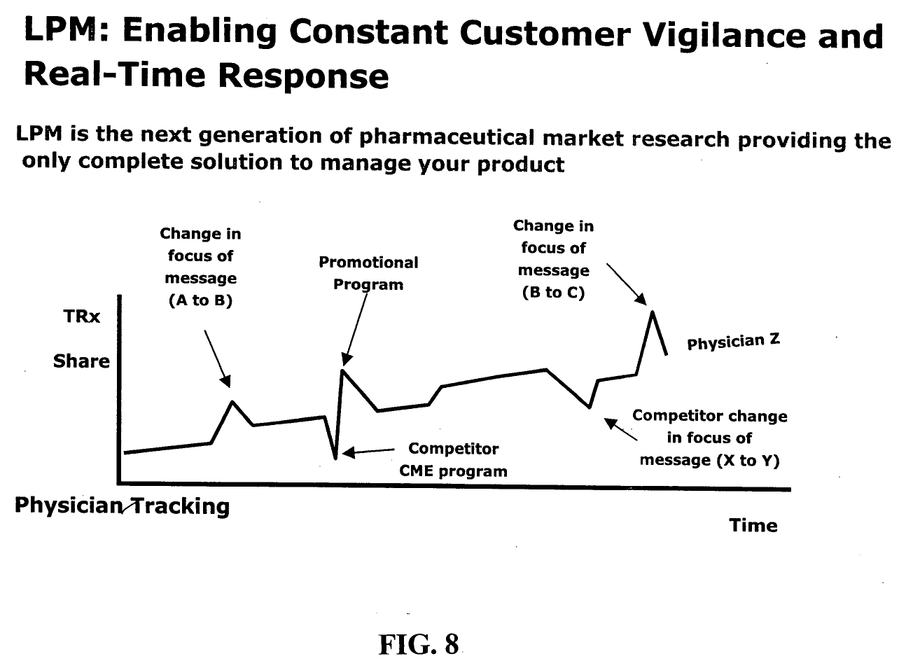

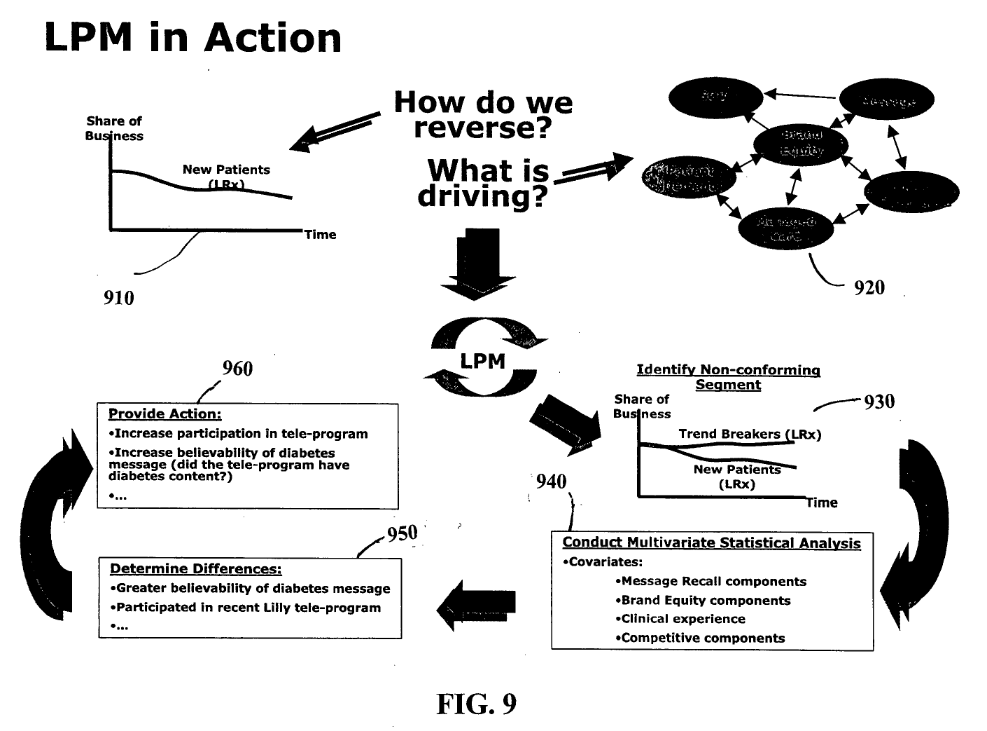

FIGS. 8 and 9 show further examples of the application of the LPM solutions to product marketing. FIG. 8 shows a graph of prescription market share (TRx) of a particular pharmaceutical product as it develops in time. The market share responds to marketing activities or events (e.g., Competitive Marketing Edge (CME) programs, Promotional programs and changes in focus of sales message), which can be timed to manage market share growth. By collecting and analyzing data obtained through continuous physician tracking, the LPM solution tracks and measures the impact of the promotional and competitor activities. The LPM solution may provide decision-making support for optimizing promotional activities (e.g., order and rotation) and help blunt competitor efforts. The LPM solution can increase targeting effectiveness and also help select the optimum media for the sales efforts.

FIG. 9 is a schematic of a case study, which exemplifies the application of the LPM solution to manage the marketing of a pharmaceutical product in a targeted market segment (e.g., New Patients segment). Graph 910 shows a declining market share for product prescriptions to new patients. The declining market share may be driven by interacting market variables 920 (e.g., patient demand, sales message content, brand equity, clinical experience, and managed care constraints). The LPM solution provides an integrated analysis of the interacting market variables and market data. The LPM solution may first identify a non-conforming market segment (Trend Breakers, graph 930). Next, the LPM solution may provide multivariate statistical analysis (940) of market factors (e.g., Message Recall, Brand Equity, Clinical Experience and Competitive components) to identify the relevant or critical marketing factors 950 which differentiate the response of the non-conforming market segment (Trend Breakers) from that of the subject market segment (New Patients). The LPM solution may then based on the identification of the relevant or critical marketing factors generate quantifiable action items 960 that are directed at improving the market share of the subject product in the targeted market segment (New Patients).

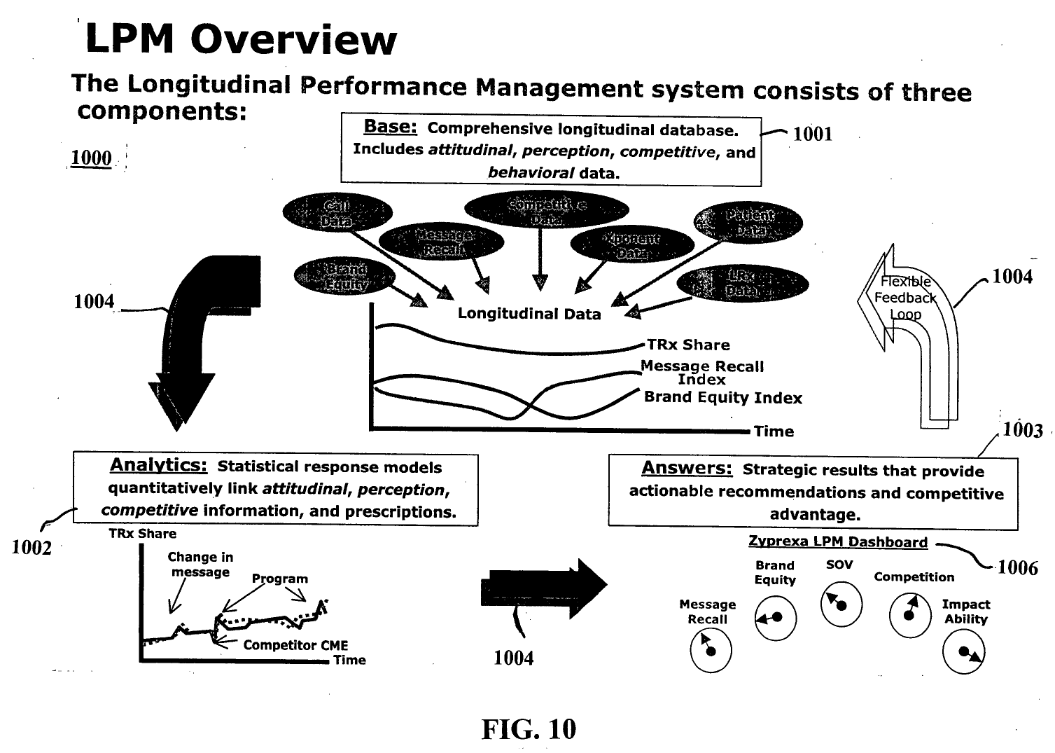

FIG. 10 shows another schematic view of the components and processes of an LPM solution 1000 for applications in the pharmaceutical and medical industry. LPM solution 1000 includes three interacting components i.e., a comprehensive longitudinal database 1001, Analytics component 1002, and an Answers or Output component 1003. The three components interface with each other in a flexible feedback arrangement 1004. Longitudinal database 1001 may include, for example, longitudinal attitudinal, perception, competitive and behavioral data and other market data such as TRx or LRx data. The longitudinal data (e.g., attitudinal, perception and behavioral data) may be acquired utilizing the services of a sample or targeted panel of physicians. The attitudinal and perception data may, for example, be monthly survey data on message recall, brand equity and share of voice (SoV). The behavioral data may be patient level LRx data including, for example, switching, continuing, restarts, concomitant use, patient segments and patient share of business data.

Analytics component 1002 may include suitable statistical response models and applications, which link the attitudinal, perception, competitive, behavioral market data with market results (e.g., prescriptions TRx or LRx data). The statistical response models may be configured to generate actionable recommendations for adjusting the marketing variables to gain competitive advantage for the subject product. In an exemplary implementation of LPM solution 1000, Analytics component 1002 includes routine response models, competitive response models, promotional efficiency models, market segmentation models, and time series trend analysis applications. The time series analysis applications are configured to determine longitudinal patterns and distributions in the market data. The routine response models measure relationships between recall, equity and performance components. The measured relationships are used to identify which market factors (e.g., recall or equity) drive market performance of a subject marketed product. Similarly, the competitive response models measure the market impact of competitor activities. The competitive response models are used to identify which competitor activities drive market performance. Further, the promotional efficiency models include non-linear programming applications, which interface the various response models and the time series trend analysis applications. The promotional efficiency models may be configured to determine opportunities to increase market performance under applicable marketing constraints (e.g., without changing the level of marketing and sales effort). Analytics component 1002 also may include a market segmentation application that is designed to identify market segments based on longitudinal recall, equity and LRx patterns.

With continued reference to FIG. 10, Answers or Output component 1003 may be configured to display results for each market variable in any suitable manner. For example, Answers or Output 1003 may be configured to display results as a dashboard 1006. Exemplary dashboard 1006 includes results indicators for variables such as message recall, brand equity, share of voice (SoV), competitor, and impact ability. A weekly or monthly dashboard may reveal the relative importance and contribution of all factors related to a product's promotion and those of competitive product promotions, patient characteristics, product attributes and perceived benefits/risks versus other brands.

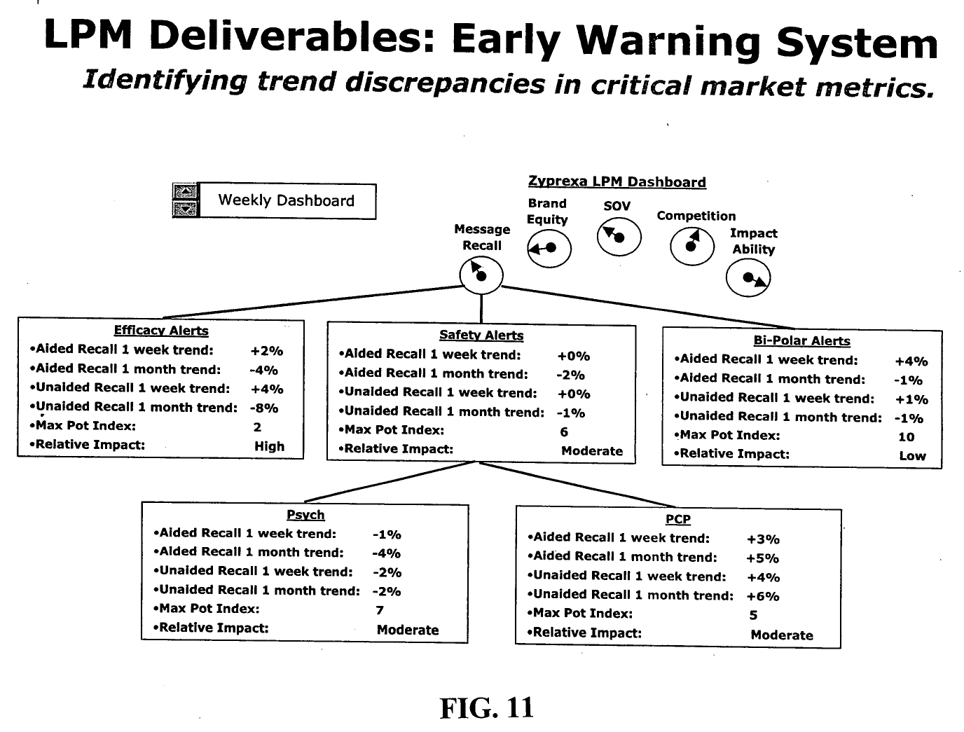

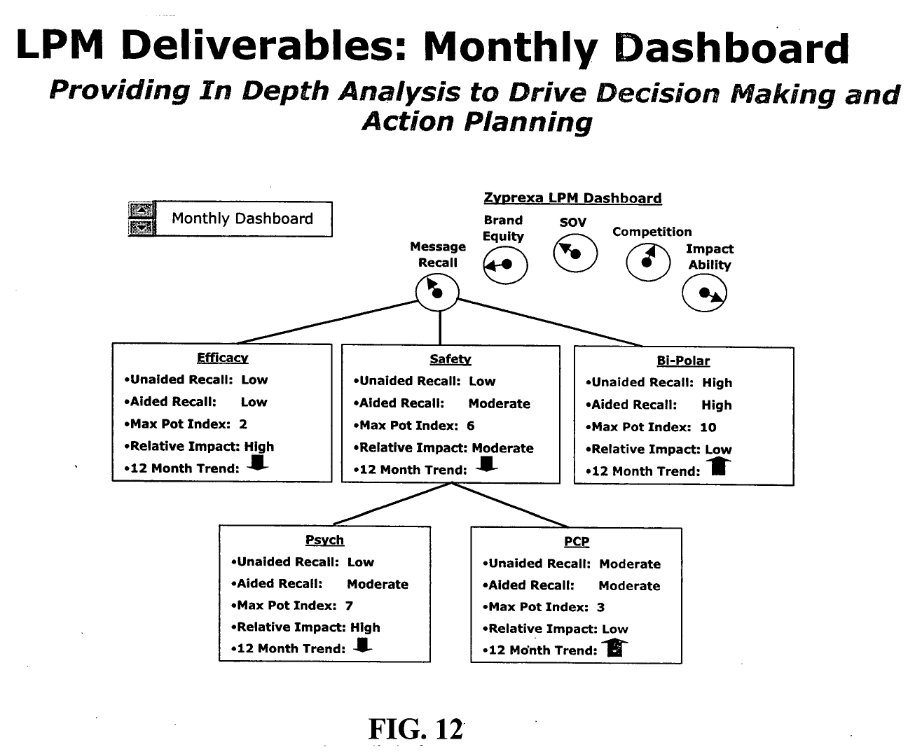

In operation, LPM solution 1000 may provide periodic market assessments (e.g., weekly or monthly). FIGS. 11 and 12 show exemplary weekly and monthly dashboard results, respectively. Detailed results are displayed under the results indicator for the message recall variable. The time period covered may include several message recall events (e.g., efficacy, safety, bi-polar, psych, and PCP alerts or updates). LPM solution 1000 through feedback loop 1004 provides detailed information on the proportional effect of each of the message recall events on the market performance of the subject product (e.g., Zyprexa).

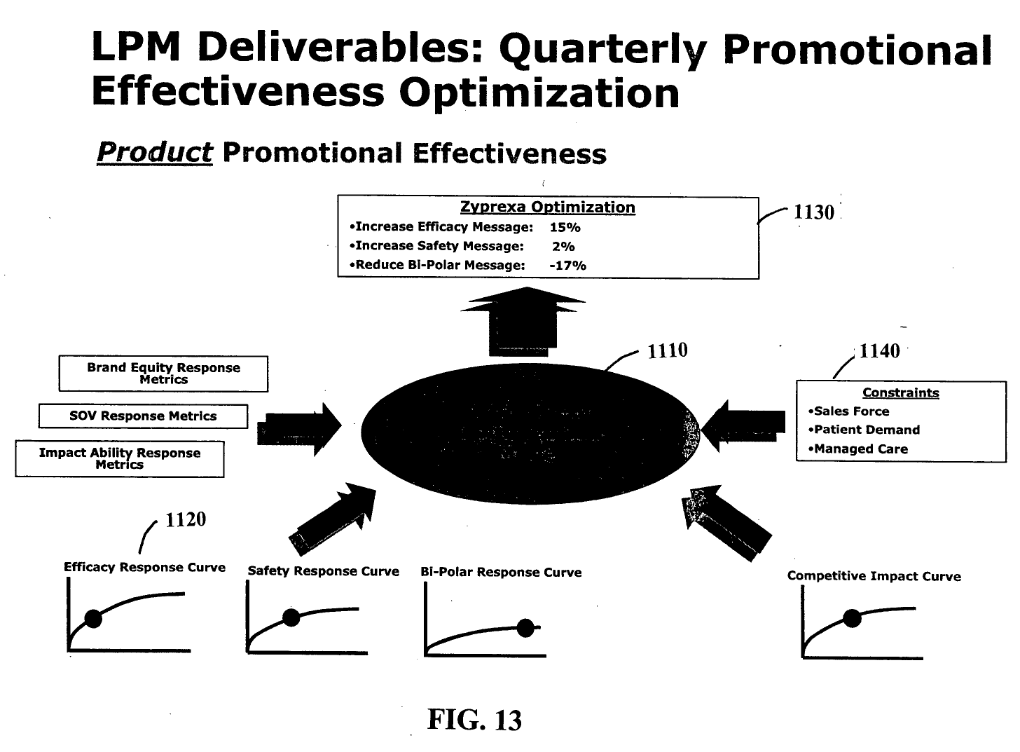

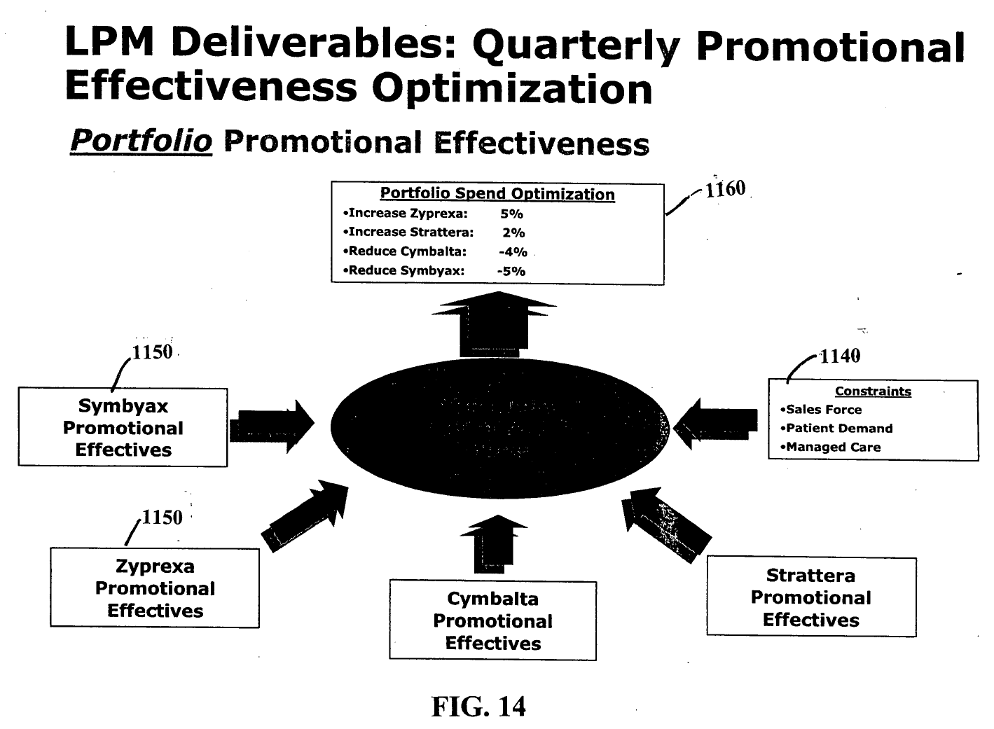

FIGS. 13 and 14 show additional examples of the application of the LPM solutions to product marketing. FIG. 13 is a schematic representation of an exemplary application of an LPM solution for promotional effectiveness optimization for a particular product (e.g., Zyprexa). For this application, the LPM solution (i.e. Analytics component 1002) may be configured to include a multi-variable non-linear optimization application 1100. Optimization application 1100 generates a set of recommended actions 1130 by analysis of the integrated outputs 1120 of suitable single variable response models for message recall, brand equity, share of voice (SoV), competitor, impact ability or other market variables. The integrated optimization analysis is conducted under market or operational constraints 1140 (e.g., sales force limitations and patient demand and managed care constraints). Exemplary set of recommended actions 1130 includes specific recommendations for modifying sales message content to improve promotion effectiveness.

FIG. 14 is a schematic representation of an exemplary application of an LPM solution for optimization of promotional effectiveness of a marketed portfolio of products (e.g., Symbax, Zyprexa, Cymbalata, and Stattera). For this application, non-linear optimization application 1110 is configured for analysis of integrated single-product promotion parameters (1150) to generate a set of recommended actions 1160. The optimization is again conducted subject to applicable market and operational constraints 1140. Exemplary set of recommended actions 1160 include specific recommendations for modifying the product mix or balance in the marketed portfolio toward desired portfolio spend targets.

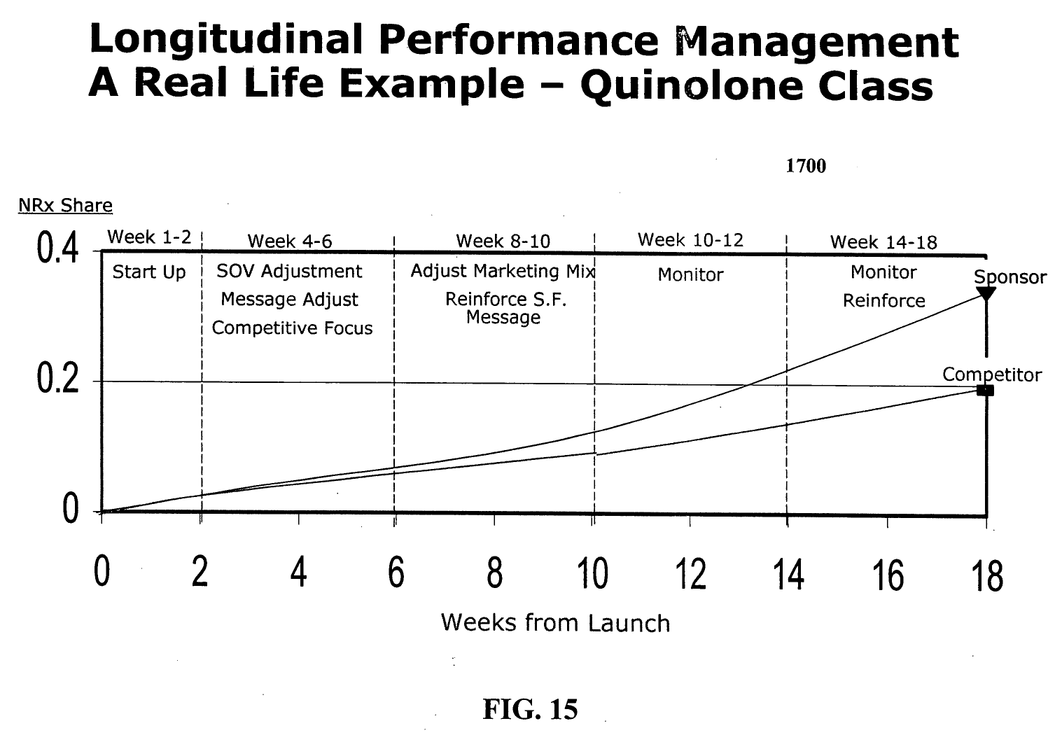

FIG. 15 is a comparative graph, which shows product marketing results obtained using LPM solutions to optimize marketing activities. Graph 1700 compares the market share of the sponsored product with the market share of a competitor's product over a period of eighteen weeks beginning with product launch. The marketing activities for the sponsored product were adjusted every few weeks according to LPM analysis of the market dynamics. Superior market share results are associated with the use of LPM solutions to optimize marketing activities.

In accordance with the present invention, software (i.e., computer program instructions) for implementing the aforementioned LPM solution can be provided on computer-readable media. It will be appreciated that each of the steps and processes (described above in accordance with this invention), and any combination of these steps and processes, can be implemented by computer program instructions. Any suitable computer programming language may be used for this purpose. The computer program instructions can be loaded onto a computer or other programmable apparatus to produce a machine, such that the instructions, which execute on the computer or other programmable apparatus create means for implementing the functions of the aforementioned LPM solution. These computer program instructions can also be stored in a computer-readable memory that can direct a computer or other programmable apparatus to function in a particular manner, such that the instructions stored in the computer-readable memory produce an article of manufacture including instruction means which implement the functions of the aforementioned LPM solution. The computer program instructions can also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of the aforementioned LPM solution. It will also be understood that the computer-readable media on which instructions for implementing the aforementioned the aforementioned LPM solution are provided, include without limitation, firmware, microcontrollers, microprocessors, integrated circuits, ASICS, and other available media.

It will be understood that the foregoing is only illustrative of the principles of the invention, and that various modifications can be made by those skilled in the art, without departing from the scope and spirit of the invention, which is limited only by the claims that follow.

1. A performance management solution (LPM) for enhancing the effectiveness of a product marketing effort, the LPM solution comprising the steps of:
(a) longitudinal data integration of primary market research data and secondary market data; and
(b) periodic analysis of the integrated data, whereby current market driving variables are identified.

2. The LPM solution of claim 1 wherein step (b) comprises non-linear multi-variate analysis.

3. The LPM solution of claim 1, further comprising the step (c) of optimizing product marketing activities in response to the identification of the current market driving variables.

4. The LPM solution of claim 3 wherein step (c) comprises using optimization algorithms coupled with marketing promotion simulators.

5. The LPM solution of claim 3 wherein step (c) comprises using optimization algorithms coupled with resource allocation algorithms.

6. The LPM solution of claim 1 wherein the product marketing effort relates to the marketing of a pharmaceutical product, and wherein the primary research data comprises prescribing-physician attitudes.

7. The LPM solution of claim 6 wherein the secondary market data comprises prescriber-by-prescriber prescription data related to the pharmaceutical product.

8. The LPM solution of claim 7 wherein step (a) further comprises integrating reference data.

9. The LPM solution of claim 1, wherein step(b) further comprises providing early warnings of changes in market conditions.

10. The LPM solution of claim 9, further comprising analyzing the market impact of the changes in market conditions.

11. The LPM solution of claim 10, further comprising generating quantifiable action items in the a product marketing effort to address the changes the changes in market conditions.

12. The LPM solution of claim 1, implemented as a software arrangement on computer-readable media.

13. A software arrangement for enhancing the effectiveness of a product marketing effort, the software arrangement comprising:
(a) a data integration component that provides longitudinally integrated primary market research data and secondary market data; and
(b) an analytical component that is configured to periodically analyze the integrated data and identify current market driving variables.

14. The software arrangement of claim 13, wherein the data integration component further provides integrated reference data.

15. The software arrangement of claim 13 wherein the analytical component comprises non-linear multivariate algorithms that are configured to identify the current market driving variables.

16. The software arrangement of claim 13 wherein the analytical component is configured to provide early warnings of changes in the product market conditions.

17. The software arrangement of claim 16 wherein the analytical component further comprises optimization algorithms that are configured to generate product marketing action items in response to the changes in the product market conditions.

18. The software arrangement of claim 13 further comprising market promotion simulators.

19. The software arrangement of claim 13 further comprising a reporting applications.

20. The software arrangement of claim 19 wherein the reporting application comprises a dashboard configured to display market variable values.
